(19) United States
(12) Patent Application Publication
(10) Pub. No.: US 2024/0232908 A1
(43) Pub. Date: Jul. 11, 2024

(54) ENTERPRISE ACTIVATION DEGREE DETERMINING METHOD AND APPARATUS, ELECTRONIC DEVICE AND STORAGE MEDIUM

(71) Applicant: CHINESE RESEARCH ACADEMY OF ENVIRONMENTAL SCIENCES, Beijing (CN)

(72) Inventors: Jianglong CUI, Beijing (CN); Lieyu ZHANG, Beijing (CN); Guowen LI, Beijing (CN); Yijun BAO, Beijing (CN); Wensi WANG, Beijing (CN); Cao LIU, Beijing (CN); Xiaoguang LI, Beijing (CN); Jiaqian LI, Beijing (CN); Chen ZHAO, Beijing (CN); Caole LI, Beijing (CN); Wei LI, Beijing (CN); Xiaolin HOU, Beijing (CN)

(73) Assignee: CHINESE RESEARCH ACADEMY OF ENVIRONMENTAL SCIENCES, Beijing (CN)

(21) Appl. No.: 18/009,356

(22) PCT Filed: Oct. 25, 2022
(86) PCT No.: PCT/CN2022/127330

§ 371 Date: Dec. 9, 2022

(30) Foreign Application Priority Data
Aug. 26, 2021 (CN) 202110990868.0

(51) Int. Cl. G06Q 30/018

(52) U.S. Cl. CPC G06Q 30/018

(57) ABSTRACT

An enterprise activation degree determining method and apparatus, an electronic device and a storage medium are provided. The method includes: acquiring original activation degree index data in P dimensions corresponding to N enterprises respectively, and performing dimensionless processing on the original activation degree index data to obtain target activation degree index data in P dimensions; calculating a correlation coefficient of target activation degree index data in every two dimensions to obtain a correlation coefficient matrix, and determining feature values and feature vectors of the correlation coefficient matrix; determining M principal components and accumulated contribution rates respectively corresponding to the M principal components based on the feature values and the feature vectors; calculating weights respectively corresponding to the target activation degree index data in the P dimensions; and determining the activation degree of each enterprise.

### CROSS REFERENCE TO THE RELATED APPLICATIONS

This application is the national phase entry of International Application No. PCT/CN2022/127330, filed on Oct. 25, 2022, which is based upon and claims priority to Chinese Patent Application No. 202110990868.0, filed on Aug. 26, 2021, the entire contents of which are incorporated herein by reference.

### TECHNICAL FIELD

The present disclosure relates to the technical field of environmental protection, in particular to an enterprise activation degree determining method and apparatus, an electronic device and a storage medium.

### BACKGROUND

In the technical field of environmental protection, knowing a real situation of an enterprise is an important foundation for “precise pollution control”. However, there are many shell enterprises and zombie enterprises in real life, and these enterprises have no actual production and business behaviors. It is of great significance to remove shell enterprises and zombie enterprises from a list of enterprises of environmental-protection supervision to achieve “precise pollution control”.

In the related art, an activation degree of an enterprise may be evaluated by analyzing enterprise data of the enterprise in a plurality of dimensions. However, an accuracy of the activation degree of the enterprise is also low due to the low accuracy of weights corresponding to the enterprise data in various dimensions.

### SUMMARY

### (I) Technical Problem to be Solved

The technical problems to be solved by the present disclosure are that an accuracy of the activation degree of the enterprise is also low due to the low accuracy of weights corresponding to the enterprise data in various dimensions.

### (II) Technical Solutions

In order to solve the above technical problems or at least partially solve the above technical problems, the present disclosure provides an enterprise activation degree determining method and apparatus, an electronic device and a storage medium.

In a first aspect, the present disclosure provides an enterprise activation degree determining method, including:
acquiring original activation degree index data in P dimensions corresponding to N enterprises respectively, and performing dimensionless processing on the original activation degree index data to obtain target activation degree index data in P dimensions respectively corresponding to the N enterprises; where both N and P are an integer greater than 1;
calculating a correlation coefficient of target activation degree index data in every two dimensions in the target activation degree index data in the P dimensions to obtain a correlation coefficient matrix, and determining feature values and feature vectors of the correlation coefficient matrix;
determining accumulated contribution rates of P components based on the feature values and the feature vectors, and determining M principal components according to the accumulated contribution rates of the P components and accumulated contribution rates respectively corresponding to the M principal components; where, each principal component is a linear combination of the target activation degree index data in the P dimensions, and M is a positive integer less than P;
calculating weights respectively corresponding to the target activation degree index data in the P dimensions according to coefficients of the target activation degree index data in the P dimensions in the M principal components and the accumulated contribution rates respectively corresponding to the M principal components; where, the coefficients of the target activation degree index data in the P dimensions are determined based on the feature vectors; and
for each enterprise, determining the activation degree of the enterprise according to the target activation degree index data in the P dimensions corresponding to the enterprise and the weights respectively corresponding to the target activation degree index data in the P dimensions

In an optional embodiment, the calculating the weights respectively corresponding to the target activation degree index data in the P dimensions according to the coefficients of the target activation degree index data in the P dimensions in the M principal components and the accumulated contribution rates respectively corresponding to the M principal components, includes:
when an i-th principal component Fᵢ is denoted as:

$$\\ {F}_{i} = {a}_{1 i} {X}_{1} + {a}_{2 i} {X}_{2} + … + {a}_{pi} {X}_{p} , i = 1 , 2 , … , M ;$$

a corresponding accumulated contribution rate corresponding to Fᵢ is denoted as pᵢ, according to the following formula:

$$\\ {w}_{k} = \frac{{\sum }_{i = 1}^{M} {a}_{ki} {P}_{i}}{{\sum }_{i = 1}^{M} {P}_{i}} , k = 1 , 2 , … , p ,$$

determining a weight wₖ corresponding to target activation degree index data in a k-th dimension, where X₁, . . . , Xₚ respectively denote target activation degree index data in the first to p-th dimensions, and a₁ᵢ, . . . , aₚᵢ are the coefficients of the target activation degree index data in the P dimensions.

In an optional embodiment, after calculating the weights respectively corresponding to the target activation degree index data in the P dimensions, the method further includes:
normalizing the weights respectively corresponding to the target activation degree index data in the P dimensions to obtain normalized weights respectively corresponding to the target activation degree index data in the P dimensions; and
the determining the activation degree of the enterprise according to the target activation degree index data in the P dimensions corresponding to the enterprise and the weights respectively corresponding to the target activation degree index data in the P dimensions, includes:
determining the activation degree of the enterprise according to the target activation degree index data in the P dimensions corresponding to the enterprise and the normalized weights respectively corresponding to the target activation degree index data in the P dimensions.

In an optional embodiment, the determining the accumulated contribution rates of the P components, and determining the M principal components according to the accumulated contribution rates of the P components and the accumulated contribution rates respectively corresponding to the M principal components, includes:
sorting the feature values in a descending order, and calculating the accumulated contribution rates of the P components based on the sorted feature values; and
when M feature values are corresponding to the accumulated contribution rates greater than the preset threshold in the accumulated contribution rates of the P components, taking the first to M-th principal components corresponding to the M feature values as the M principal components.

In an optional embodiment, the performing the dimensionless processing on the original activation degree index data to obtain the target activation degree index data in the P dimensions respectively corresponding to the N enterprises, includes:
calculating an average value and a standard deviation of the original activation degree index data in a q-th dimension of the N enterprises; and
for each enterprise, dividing a difference between the original activation degree index data in the q-th dimension of the enterprise and the average value by the standard deviation as target activation degree index data in the q-th dimension of the enterprise.

In an optional embodiment, before performing the dimensionless processing on the original activation degree index data, the method further includes:
performing at least one of index forward processing and index normalization processing on the original activation degree index data to obtain pre-processed activation degree index data; and
the performing the dimensionless processing on the original activation degree index data, includes:
performing dimensionless processing on the pre-processed activation degree index data.

In an optional embodiment, the method further includes:
after determining the activation degrees of the N enterprises, dividing the activation degrees of the N enterprises into a plurality of different activation degree levels, and excluding enterprises contained in the lowest activation degree level.

In a second aspect, the present disclosure provides an enterprise activation degree determining apparatus, including:
a dimensionless processing module configured for acquiring original activation degree index data in P dimensions corresponding to N enterprises respectively, and performing dimensionless processing on the original activation degree index data to obtain target activation degree index data in P dimensions respectively corresponding to the N enterprises; where both N and P are an integer greater than 1;
a feature value and feature vector determining module configured for calculating a correlation coefficient of target activation degree index data in every two dimensions in the target activation degree index data in the P dimensions to obtain a correlation coefficient matrix, and determining feature values and feature vectors of the correlation coefficient matrix;
a principal component and accumulated contribution rate determining module configured for determining accumulated contribution rates of P components based on the feature values and the feature vectors, and determining M principal components according to the accumulated contribution rates of the P components and accumulated contribution rates respectively corresponding to the M principal components; where, each principal component is a linear combination of the target activation degree index data in the P dimensions, and M is a positive integer less than P;
a weight determining module configured for calculating weights respectively corresponding to the target activation degree index data in the P dimensions according to coefficients of the target activation degree index data in the P dimensions in the M principal components and the accumulated contribution rates respectively corresponding to the M principal components; where, the coefficients of the target activation degree index data in the P dimensions are determined based on the feature vectors; and
an activation degree determining module configured for, for each enterprise, determining the activation degree of the enterprise according to the target activation degree index data in the P dimensions corresponding to the enterprise and the weights respectively corresponding to the target activation degree index data in the P dimensions.

In an optional embodiment, the weight determining module is specifically configured for, when an i-th principal component Fᵢ is denoted as:

$$\\ {F}_{i} = {a}_{1 i} {X}_{1} + {a}_{2 i} {X}_{2} + … + {a}_{pi} {X}_{p} , i = 1 , 2 , … , M ;$$

a corresponding accumulated contribution rate corresponding to Fᵢ is denoted as pᵢ, according to the following formula:

$$\\ {w}_{k} = \frac{{\sum }_{i = 1}^{M} {a}_{ki} {P}_{i}}{{\sum }_{i = 1}^{M} {P}_{i}} , k = 1 , 2 , … , p ,$$

determining a weight wₖ corresponding to target activation degree index data in a k-th dimension, where X₁, . . . , Xₚ respectively denote target activation degree index data in the first to p-th dimensions, and a₁ᵢ, . . . , aₚᵢ are the coefficients of the target activation degree index data in the P dimensions.

In an optional embodiment, the enterprise activation degree determining apparatus further includes:
a normalizing module configured for normalizing the weights respectively corresponding to the target activation degree index data in the P dimensions to obtain normalized weights respectively corresponding to the target activation degree index data in the P dimensions; and
the activation degree determining module configured for, for each enterprise, determining the activation degree of the enterprise according to the target activation degree index data in the P dimensions corresponding to the enterprise and the normalized weights respectively corresponding to the target activation degree index data in the P dimensions.

In an optional embodiment, the principal component and accumulated contribution rate determining module is specifically configured for sorting the feature values in a descending order, and calculating the accumulated contribution rates of the P components based on the sorted feature values; and when M feature values are corresponding to the accumulated contribution rates greater than the preset threshold in the accumulated contribution rates of the P components, taking the first to M-th principal components corresponding to the M feature values as the M principal components.

In an optional embodiment, the dimensionless processing module is specifically configured for acquiring the original activation degree index data in the P dimensions respectively corresponding to the N enterprises, and calculating an average value and a standard deviation of the original activation degree index data in a q-th dimension of the N enterprises; and for each enterprise, dividing a difference between the original activation degree index data in the q-th dimension of the enterprise and the average value by the standard deviation as target activation degree index data in the q-th dimension of the enterprise.

In an optional embodiment, the enterprise activation degree determining apparatus further includes:
a preprocessing module configured for performing at least one of index forward processing and index normalization processing on the original activation degree index data to obtain pre-processed activation degree index data; and
the dimensionless processing module is specifically configured for performing dimensionless processing on the pre-processed activation degree index data to obtain the target activation degree index data in the P dimensions respectively corresponding to the N enterprises.

In an optional embodiment, the enterprise activation degree determining apparatus further includes:
an excluding module configured for, after determining the activation degrees of the N enterprises, dividing the activation degrees of the N enterprises into a plurality of different activation degree levels, and excluding enterprises contained in the lowest activation degree level.

In a third aspect, the present disclosure provides an electronic device, including: a processor, where the processor is configured for executing a computer program stored in a memory, and the computer program, when executed by the processor, implements the method according to the first aspect.

In a fourth aspect, the present disclosure provides a computer-readable storage medium storing a computer program thereon, where the computer program, when executed by a processor, implements the method according to the first aspect.

In a fifth aspect, the present disclosure provides a computer program product, where the computer program product, when running on a computer, enables the computer to execute the method according to the first aspect.

### (III) Beneficial Effects

Compared with the prior art, the technical solutions provided by the embodiments of the present disclosure have the following advantages.

The dimensionless processing is performed on the original activation degree index data in the P dimensions to obtain the target activation degree index data in the P dimensions respectively corresponding to the N enterprises, so as to eliminate the influence of dimensions, and make the evaluation results more interpretable. Through the principal component analysis method, dimension reduction process is performed on the target activation degree index data in the P dimensions to determine the M principal components and the accumulated contribution rates respectively corresponding to the M principal components where M is a positive integer less than P. Because each principal component is the linear combination of the target activation degree index data in the P dimensions, the weights respectively corresponding to the target activation degree index data in the P dimensions are calculated by combining the accumulated contribution rates corresponding to each principal component. For example, the coefficients of the target activation degree index data in the same dimension in the principal components may be weighted and averaged, so that the accuracy of weight determining can be improved. Furthermore, for each enterprise, the activation degree of the enterprise is determined according to the target activation degree index data in the P dimensions corresponding to the enterprise and the weights respectively corresponding to the target activation degree index data in the P dimensions, so that the accuracy of activation degree determining can be improved.

### BRIEF DESCRIPTION OF THE DRAWINGS

The accompanying drawings herein are incorporated into the specification and constitute a part of the specification, illustrate the embodiments in conformity with the present disclosure, and serve to explain the principles of the present disclosure together with the specification.

FIG. 1 is a flowchart of an enterprise activation degree determining method provided by the embodiments of the present disclosure;

FIG. 2 is another flowchart of the enterprise activation degree determining method provided by the embodiments of the present disclosure;

FIG. 3 is a schematic structural diagram of an enterprise activation degree determining apparatus provided by the embodiments of the present disclosure; and

FIG. 4 is a schematic structural diagram of an electronic device provided by the embodiments of the present disclosure.

### DETAILED DESCRIPTION OF THE EMBODIMENTS

In order to better understand the above objects, features and advantages of the present disclosure, the solutions of the present disclosure will be further described below. It should be noted that, in case of no conflict, the embodiments in the present disclosure and the features in the embodiments may be arbitrarily combined with each other.

In the following description, many specific details are set forth in order to fully understand the present disclosure, but the present disclosure may be implemented in other ways different from those described herein. Obviously, the embodiments described in the specification are merely a part of, rather than all of, the embodiments of the present disclosure.

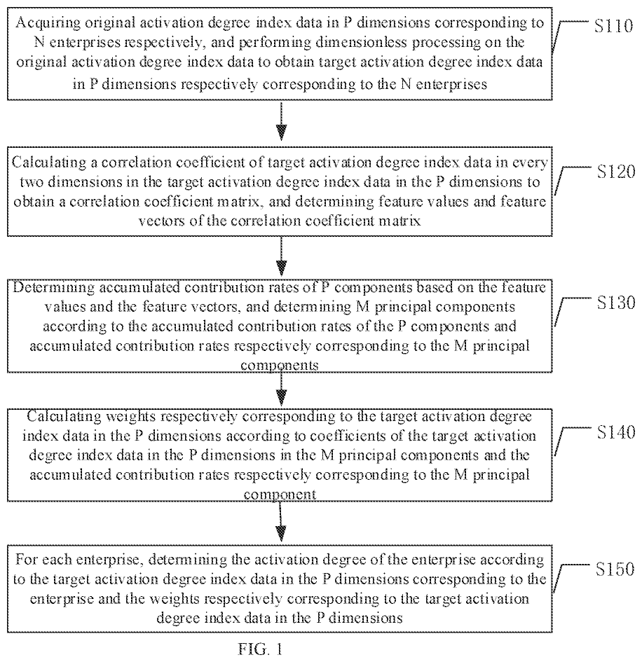

Referring to FIG. 1, FIG. 1 is a flow chart of an enterprise activation degree determining method in the embodiments of the present disclosure, where the method may include the following steps.

Step S110: acquiring original activation degree index data in P dimensions corresponding to N enterprises respectively, and performing dimensionless processing on the original activation degree index data to obtain target activation degree index data in P dimensions respectively corresponding to the N enterprises; where both N and P are an integer greater than 1.

In the embodiments of the present disclosure, the activation degrees of the plurality of enterprises may be evaluated from a plurality of dimensions. For each enterprise, the enterprise data in the same dimension may be used for evaluation, which may include the enterprise data in at least one of the following dimensions: “enterprise entry-to-market activation degree”, “enterprise transaction activation degree”, “enterprise business activation degree”, “enterprise online activation degree”, “enterprise personnel activation degree” and “enterprise innovation activation degree”.

Each dimension may contain a variety of index data. For example, the enterprise data of the “enterprise entry-to-market activation degree” may include basic data of industry and commerce, market supervision departments and data of other relevant departments. The basic data of industry and commerce and market supervision departments may include the index data in the following dimensions: establishment (including the establishment of branches), change, filing, advertising registration, consumer complaints, administrative punishment, cancellation/revocation, and the like; and the data of other relevant departments may include the index data in the following dimensions: administrative punishment information, administrative licensing information, bank card dynamic information, tax payment dynamic information, and the like.

The original activation degree index data in a single dimension refers to original and unprocessed enterprise data. It can be seem from the above that the “enterprise entry-to-market activation degree” corresponds to original activation degree index data in a plurality of dimensions, and other dimensions (“enterprise transaction activation degree”, “enterprise business activation degree”, “enterprise online activation degree”, “enterprise personnel activation degree” and “enterprise innovation activation degree” and the like) also correspond to original activation degree index data in a plurality of dimensions. Therefore, the original activation degree index data in the P dimensions refers to data with a higher dimension.

Because the original activation degree index data in different dimensions have different meanings, and there is no uniform measurement unit (dimension) for each index data in an index system; even if some index data units are the same, their actual meanings may be different. If the original activation degree index data is directly synthesized, evaluation results can't be explained. Therefore, before the comprehensive evaluation of indexes, dimensionless processing may be performed on various original activation degree index data first. Optionally, dimensionless processing may be performed by using a range method or a normal normalization processing method.

The range method is specifically as follows: when a maximum value of the original activation degree index data in a certain dimension is M and a minimum value thereof is m, then the original activation degree index data x can be dimensionless as

$$\\ \frac{x - m}{M - m} .$$

The normal normalization processing method is specifically as follows: calculating an average value and a standard deviation of the original activation degree index data in a q-th dimension of the N enterprises. For each enterprise, a difference between the original activation degree index data in the q-th dimension of the enterprise and the average value is divided by the standard deviation as target activation degree index data in the q-th dimension of the enterprise. That is, when the average value of the original activation degree index data in a certain dimension is m and the standard deviation is s, then the original activation degree index data x may be dimensionless as (x−m)/s.

Step S120: calculating a correlation coefficient of target activation degree index data in every two dimensions in the target activation degree index data in the P dimensions to obtain a correlation coefficient matrix, and determining feature values and feature vectors of the correlation coefficient matrix.

Because the target activation degree index data in the P dimensions usually has certain correlation, it is very difficult to determine an influence weight of the data in the P dimensions on the target. However, principal component analysis can transform a plurality of related index data into several unrelated new comprehensive indexes. By studying an internal structural relationship of the index system, a plurality of index data can be transformed into a few comprehensive indexes (principal components) that are unrelated to each other and contain most of the information of the original indexes (generally more than 85%).

Specifically, the correlation coefficient of the target activation degree index data in every two dimensions may be calculated to obtain the correlation coefficient matrix.

The correlation coefficient matrix may be denoted as

$$R = [ \begin{matrix}{r}_{11} & {r}_{12} & … & {r}_{1 p} \\ {r}_{21} & {r}_{22} & … & {r}_{2 p} \\ … & … & … & … \\ {r}_{p 1} & {r}_{p 2} & … & {r}_{pp}\end{matrix} ] ,$$

where, rᵢⱼ represents a correlation coefficient between the target activation degree index data in an i-th dimension and the target activation degree index data in a j-th dimension.

According to the correlation coefficient matrix, the feature value λₗ(l=1, 2, . . . , p) and the feature vector may be obtained by solving the equation |λI−R|=0.

Step S130: determining accumulated contribution rates of P components based on the feature values and the feature vectors, and determining M principal components according to the accumulated contribution rates of the P components and accumulated contribution rates respectively corresponding to the M principal components; where, each principal component is a linear combination of the target activation degree index data in the P dimensions, and M is a positive integer less than P.

In the embodiments of the present disclosure, the feature values may be sorted in a descending order, so that λ₁≥λ₂≥ . . . λₚ≥0, and the feature vector corresponding to the feature value λₗ is aₗ, which is denoted as follows:

$${a}_{1} = [ \begin{matrix}{a}_{11} \\ {a}_{21} \\ ⋮ \\ {a}_{p 1}\end{matrix} ] , {a}_{2} = [ \begin{matrix}{a}_{12} \\ {a}_{22} \\ ⋮ \\ {a}_{p 2}\end{matrix} ] , … , {a}_{p} = [ \begin{matrix}{a}_{1 p} \\ {a}_{2 p} \\ ⋮ \\ {a}_{pp}\end{matrix} ] .$$

Based on the sorted feature values, the accumulated contribution rates of the P components are calculated, which may specifically be: calculating a contribution rate of a l-th component according to the formula

$${p}_{l} = \frac{{λ}_{l}}{{\sum }_{d = 1}^{p} {λ}_{d}} ( l = 1 , 2 , … , p ) ,$$

and
calculating an accumulated contribution rate of the l-th component according to the formula

$${p}_{l} = \frac{{\sum }_{d = 1}^{l} {λ}_{d}}{{\sum }_{d = 1}^{p} {λ}_{d}} ( l = 1 , 2 , … , p ) .$$

When M feature values are corresponding to the accumulated contribution rates greater than the preset threshold (for example, 85%) in the accumulated contribution rates of the P components, the first to M-th principal components corresponding to the M feature values are taken as the M principal components. Each principal component is a linear combination of the target activation degree index data in the P dimensions, and an i-th principal component Fᵢ is denoted as:

$${F}_{i} = {a}_{1 i} {X}_{1} + {a}_{2 i} {X}_{2} + … + {a}_{p i} {X}_{p} , i = 1 , 2 , … , M .$$

Step S140: calculating weights respectively corresponding to the target activation degree index data in the P dimensions according to coefficients of the target activation degree index data in the P dimensions in the M principal components and the accumulated contribution rates respectively corresponding to the M principal components. The coefficients of the target activation degree index data in the P dimensions are determined based on the feature vectors.

For different principal components, the corresponding accumulated contribution rates are different, and the contributions of the target activation degree index data in the same dimension in different principal components to the principal components are different. Therefore, the weights respectively corresponding to the target activation degree index data in the P dimensions may be calculated based on the two types of information above.

Optionally, when the i-th principal component Fᵢ is denoted as:

$${F}_{i} = {a}_{1 i} {X}_{1} + {a}_{2 i} {X}_{2} + … + {a}_{p i} {X}_{p} , i = 1 , 2 , … , M ;$$

a corresponding accumulated contribution rate corresponding to Fᵢ is denoted as pᵢ, according to the following formula:

$${w}_{k} = \frac{{\sum }_{i = 1}^{M} {a}_{k i} {P}_{i}}{{\sum }_{i = 1}^{M} {P}_{i}} , k = 1 , 2 , … , p ,$$

determining a weight wₖ corresponding to target activation degree index data in a k-th dimension, where X₁, . . . , Xₚ respectively denote target activation degree index data in the first to p-th dimensions, and a₁ᵢ, . . . , aₚᵢ are the coefficients of the target activation degree index data in the P dimensions.

That is, the coefficients of the target activation degree index data in the linear combination of the principal components are weighted and averaged. In this way, the obtained weights are more in line with the actual situation and have higher accuracy.

Step S150: for each enterprise, determining the activation degree of the enterprise according to the target activation degree index data in the P dimensions corresponding to the enterprise and the weights respectively corresponding to the target activation degree index data in the P dimensions.

After obtaining the weights respectively corresponding to the target activation degree index data in the P dimensions, the target activation degree index data in the P dimensions of each enterprise may be directly weighted and averaged to obtain the activation degree of each enterprise.

According to the enterprise activation degree determining method of the embodiments of the present disclosure, dimensionless processing is performed on the original activation degree index data in the P dimensions to obtain the target activation degree index data in the P dimensions respectively corresponding to the N enterprises, so as to eliminate the influence of dimensions, and make the evaluation results more interpretable. Through the principal component analysis method, dimension reduction process is performed on the target activation degree index data in the P dimensions to determine the M principal components and the accumulated contribution rates respectively corresponding to the M principal components where M is a positive integer less than P. Because each principal component is the linear combination of the target activation degree index data in the P dimensions, the weights respectively corresponding to the target activation degree index data in the P dimensions are calculated by combining the accumulated contribution rates corresponding to each principal component. For example, the coefficients of the target activation degree index data in the same dimension in the principal components may be weighted and averaged, so that the accuracy of weight determining can be improved. Furthermore, for each enterprise, the activation degree of the enterprise is determined according to the target activation degree index data in the P dimensions corresponding to the enterprise and the weights respectively corresponding to the target activation degree index data in the P dimensions, so that the accuracy of activation degree determining can be improved.

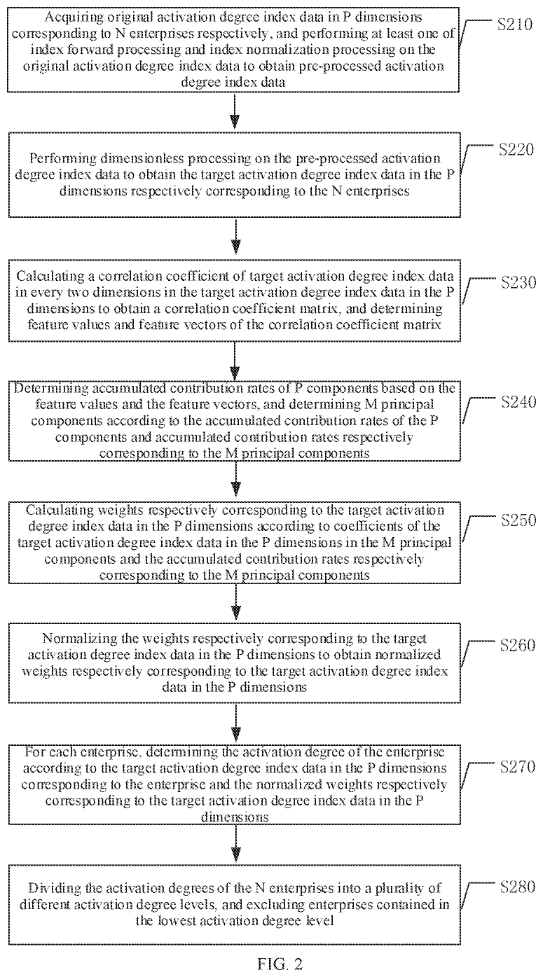

Referring to FIG. 2, FIG. 2 is a flow chart of another enterprise activation degree determining method in the embodiments of the present disclosure, where the method may include the following steps.

Step S210: acquiring original activation degree index data in P dimensions corresponding to N enterprises respectively, and performing at least one of index forward processing and index normalization processing on the original activation degree index data to obtain pre-processed activation degree index data. Both N and P are an integer greater than 1.

The original activation degree index data may usually be divided into three categories: a positive index, i.e., an index which is the bigger the better; an inverse index, i.e., an index which is the smaller the better; and a moderate index, i.e., an index which should not be too large or too small, but is best to reach a moderate value or moderate interval. The moderate index may also be regarded as a combination of the positive and inverse indexes, which can be converted into positive and inverse indexes before and after a moderate point as long as the moderate point is found.

When the original activation degree index data contains inverse index data and moderate index data, the inverse index data and the moderate index data may be positively processed to ensure consistency of evaluation targets. Forward processing may be performed on the inverse index by a method of reciprocal or taking an absolute value after a maximum value minus an original value. A method of performing the forward processing on the moderate index may be: subtracting a preset moderate value of the index from the original value, and then taking the absolute value, thus transforming the moderate index into the inverse index. Then, the inverse index is transformed into the positive index by the forward processing method of the inverse index. Certainly, the forward processing method is not limited to this.

The index normalization processing is a method to eliminate an influence of an original index value dimension through mathematical transformation. In the process of establishing the index system, there may be indexes with large order of magnitude (such as GDP) and indexes with small order of magnitude (such as deposit interest rate). When the indexes included in the index system differ greatly in magnitude, the indexes with larger magnitude tend to occupy a more influential position in the index system, which reduces the influence of the indexes with smaller magnitude on the comprehensive indexes. In most cases, this goes against an original intention of constructing the index system, because an importance of a certain index in the index system should not depend on an order of magnitude of the index. Therefore, normalization processing may be performed on the original activation degree index data. Alternatively, the normalization processing may be performed on the original activation degree index data after the original activation degree index data is subjected to forward processing.

A method of normalization processing may be: centralization, logarithmization, and the like. The method of centralization may specifically be: setting an average value of the index be m, and a value of the original activation degree index data be x, then the data after the normalization processing is x-m. This method is generally applicable to a case where the index value changes in a small range.

The method of logarithmization may specifically be: setting the original activation degree index data value of the index be x, then the dimensionless of the index is logₐf(x), where f(x) is a function of x, which is generally a linear function. According to different requirements, different values may be taken for a and f(x), where a is generally taken as 10 or natural logarithm e, and f(x) is generally taken as x or 1+x.

Step S220: performing dimensionless processing on the pre-processed activation degree index data to obtain the target activation degree index data in the P dimensions respectively corresponding to the N enterprises.

Step S230: calculating a correlation coefficient of target activation degree index data in every two dimensions in the target activation degree index data in the P dimensions to obtain a correlation coefficient matrix, and determining feature values and feature vectors of the correlation coefficient matrix.

Step S240: determining accumulated contribution rates of P components based on the feature values and the feature vectors, and determining M principal components according to the accumulated contribution rates of the P components and accumulated contribution rates respectively corresponding to the M principal components; where, each principal component is a linear combination of the target activation degree index data in the P dimensions, and M is a positive integer less than P.

Step S250: calculating weights respectively corresponding to the target activation degree index data in the P dimensions according to coefficients of the target activation degree index data in the P dimensions in the M principal components and the accumulated contribution rates respectively corresponding to the M principal components; where, the coefficients of the target activation degree index data in the P dimensions are determined based on the feature vectors.

The same parts in the step S220 to the step S250 as those in the embodiment of FIG. 1 may be referred to the description in the embodiment of FIG. 1, and will not be repeated here.

Step S260: normalizing the weights respectively corresponding to the target activation degree index data in the P dimensions to obtain normalized weights respectively corresponding to the target activation degree index data in the P dimensions.

In general, a sum of the weights of all indexes is 1, so after the weights respectively corresponding to the target activation degree index data in the P dimensions are obtained, normalizing may be performed to obtain the corresponding normalized weights.

Step S270: for each enterprise, determining the activation degree of the enterprise according to the target activation degree index data in the P dimensions corresponding to the enterprise and the normalized weights respectively corresponding to the target activation degree index data in the P dimensions.

Accordingly, the activation degree of the enterprise may also be determined based on the normalized weights respectively corresponding to the target activation degree index data in the P dimensions.

Step S280: dividing the activation degrees of the N enterprises into a plurality of different activation degree levels, and excluding enterprises contained in the lowest activation degree level.

In the embodiments of the present disclosure, after determining the activation degree of the N enterprises, the activation degree of the N enterprises may also be divided into the plurality of different activation degree levels, for example, may be divided into three activation degree levels (high, medium and low). The three activation degree levels correspond to different activation degree ranges. The lower the activation degree level, the less active the enterprise in this activation degree level is, and the more likely the enterprise is to be a zombie enterprise or a shell enterprise. Therefore, enterprises contained in the lowest activation degree level can be eliminated, so that supervisors can avoid wasting manpower and improve supervision efficiency when supervising enterprises.

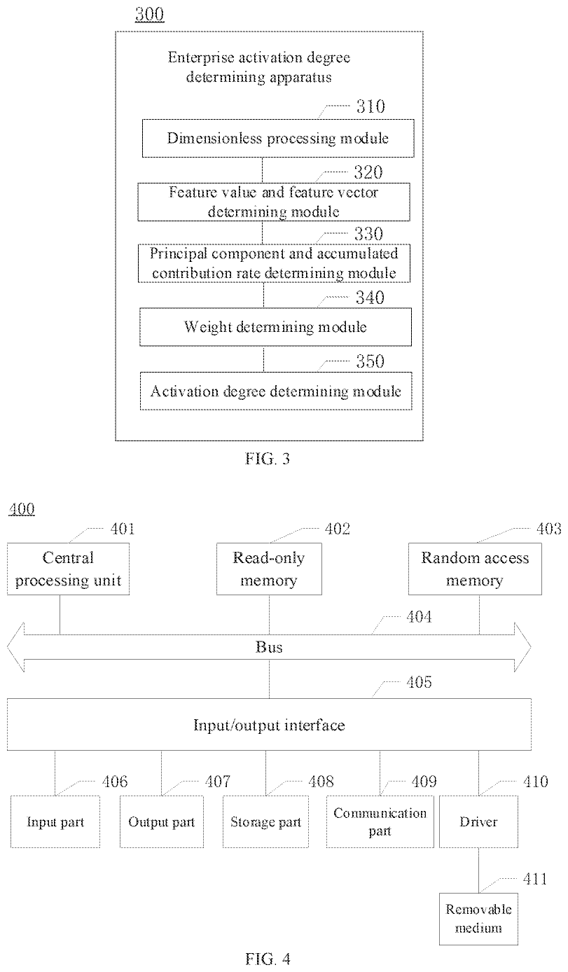

Corresponding to the above method embodiments, the embodiments of the present disclosure also provide an enterprise activation degree determining apparatus. Referring to FIG. 3, the enterprise activation degree determining apparatus 300 includes:
a dimensionless processing module 310 configured for acquiring original activation degree index data in P dimensions corresponding to N enterprises respectively, and performing dimensionless processing on the original activation degree index data to obtain target activation degree index data in P dimensions respectively corresponding to the N enterprises; where both N and P are an integer greater than 1;
a feature value and feature vector determining module 320 configured for calculating a correlation coefficient of target activation degree index data in every two dimensions in the target activation degree index data in the P dimensions to obtain a correlation coefficient matrix, and determining feature values and feature vectors of the correlation coefficient matrix;
a principal component and accumulated contribution rate determining module 330 configured for determining accumulated contribution rates of P components based on the feature values and the feature vectors, and determining M principal components according to the accumulated contribution rates of the P components and accumulated contribution rates respectively corresponding to the M principal components; where, each principal component is a linear combination of the target activation degree index data in the P dimensions, and M is a positive integer less than P;
a weight determining module 340 configured for calculating weights respectively corresponding to the target activation degree index data in the P dimensions according to coefficients of the target activation degree index data in the P dimensions in the M principal components and the accumulated contribution rates respectively corresponding to the M principal components; where, the coefficients of the target activation degree index data in the P dimensions are determined based on the feature vectors; and
an activation degree determining module 350 configured for, for each enterprise, determining the activation degree of the enterprise according to the target activation degree index data in the P dimensions corresponding to the enterprise and the weights respectively corresponding to the target activation degree index data in the P dimensions.

In an optional embodiment, the weight determining module is specifically configured for, when an i-th principal component Fᵢ is denoted as:

$${F}_{i} = {a}_{1 i} {X}_{1} + {a}_{2 i} {X}_{2} + … + {a}_{p i} {X}_{p} , i = 1 , 2 , … , M ;$$

a corresponding accumulated contribution rate corresponding to Fᵢ is denoted as pᵢ, according to the following formula:

$${w}_{k} = \frac{{\sum }_{i = 1}^{M} {a}_{k i} {P}_{i}}{{\sum }_{i = 1}^{M} {P}_{i}} , k = 1 , 2 , … , p ,$$

determining a weight wₖ corresponding to target pᵢ, activation degree index data in a k-th dimension, where X₁, . . . , Xₚ respectively denote target activation degree index data in the first to p-th dimensions, and a₁ᵢ, . . . , aₚᵢ are the coefficients of the target activation degree index data in the P dimensions.

In an optional embodiment, the enterprise activation degree determining apparatus further includes:
a normalizing module configured for normalizing the weights respectively corresponding to the target activation degree index data in the P dimensions to obtain normalized weights respectively corresponding to the target activation degree index data in the P dimensions; and
the activation degree determining module configured for, for each enterprise, determining the activation degree of the enterprise according to the target activation degree index data in the P dimensions corresponding to the enterprise and the normalized weights respectively corresponding to the target activation degree index data in the P dimensions.

In an optional embodiment, the principal component and accumulated contribution rate determining module is specifically configured for sorting the feature values in a descending order, and calculating the accumulated contribution rates of the P components based on the sorted feature values; and when M feature values are corresponding to the accumulated contribution rates greater than the preset threshold in the accumulated contribution rates of the P components, taking the first to M-th principal components corresponding to the M feature values as the M principal components.

In an optional embodiment, the dimensionless processing module is specifically configured for acquiring the original activation degree index data in the P dimensions respectively corresponding to the N enterprises, and calculating an average value and a standard deviation of the original activation degree index data in a q-th dimension of the N enterprises; and for each enterprise, dividing a difference between the original activation degree index data in the q-th dimension of the enterprise and the average value by the standard deviation as target activation degree index data in the q-th dimension of the enterprise.

In an optional embodiment, the enterprise activation degree determining apparatus further includes:
a preprocessing module configured for performing at least one of index forward processing and index normalization processing on the original activation degree index data to obtain pre-processed activation degree index data; and
the dimensionless processing module is specifically configured for performing dimensionless processing on the pre-processed activation degree index data to obtain the target activation degree index data in the P dimensions respectively corresponding to the N enterprises.

In an optional embodiment, the enterprise activation degree determining apparatus further includes:
an excluding module configured for, after determining the activation degrees of the N enterprises, dividing the activation degrees of the N enterprises into a plurality of different activation degree levels, and excluding enterprises contained in the lowest activation degree level.

The specific details of each module or unit in the apparatus above have been described in detail in the corresponding method, and thus will not be elaborated herein.

It should be noted that while a plurality of modules or units of the device for action execution have been mentioned in the detailed description above, this division is not mandatory. In fact, according to the embodiments of the present disclosure, the features and functions of the two or more modules or units described above may be embodied in one module or unit. On the contrary, the features and functions of one module or unit described above can be further divided into being embodied by more modules or units.

An exemplary embodiment of the present disclosure further provides an electronic device, including: a processor; and a memory configured for storing instructions executable by the processor; where, the processor is configured for executing the enterprise activation degree determining method in the exemplary embodiment above.

FIG. 4 is a schematic structural diagram of an electronic device provided by the embodiments of the present disclosure. It should be noted that the electronic device 400 illustrated in FIG. 4 is merely an example and should not impose any limitation on the function and range of application of the embodiments of the present disclosure.

As shown in the FIG. 4, the electronic device 400 includes a central processing unit (CPU) 401, which can perform various appropriate actions and processes according to a program stored in a read-only memory (ROM) 402 or loaded from a storage part 408 into a random access memory (RAM) 403. In the RAM 403, various programs and data needed for system operating may also be stored. The central processing unit 401, the ROM 402, and the RAM 403 are connected to each other through a bus 404. An input/output (I/O) interface 405 is also connected to the bus 404.

The following components are connected to the I/O interface 405: an input part 406 including a keyboard, a mouse, and the like; an output part 407 including, for example, a cathode ray tube (CRT), a liquid crystal display (LCD), a loud speaker and the like; a storage part 408 including a hard disk and the like; and a communication part 409 including a network interface card such as a local area network (LAN) card, a modem and the like. The communication part 409 performs communication processing via a network such as the Internet. A driver 410 is also connected to the I/O interface 405 as needed. A removable medium 411, such as a magnetic disk, an optical disk, a magneto-optical disk, a semiconductor memory, and the like, is installed on the driver 410 as needed, so that a computer program read therefrom can be installed into the storage part 408 as needed.

Particularly, according to the embodiments of the present disclosure, the process described above with reference to the flow chart can be implemented as a computer software program. For example, the embodiments of the present disclosure include a computer program product, which includes a computer program carried on a computer-readable medium, and the computer program contains a program code for executing the method shown in the flow chart. In such embodiments, the computer program may be downloaded and installed from the network through the communication part 409, and/or installed from the removable medium 411. When the computer program is executed by the central processing unit (CPU) 401, various functions defined in the apparatus of the present disclosure are executed.

The embodiments of the present disclosure further provide a computer-readable storage medium storing a computer program thereon, where the computer program, when executed by a processor, implements the enterprise activation degree determining method above.

It should be noted that the computer-readable storage medium shown in the present disclosure may be, for example, but is not limited to, an electronic, magnetic, optical, electromagnetic, infrared, or semiconductor system, apparatus, or device, or any combination of the above. More specific examples of the computer-readable storage medium may include, but are not limited to, an electrical connection with one or more wires, a portable computer disk, a hard disk, a random access memory, a read-only memory, an erasable programmable read only memory (EPROM or flash), an optical fiber, a portable compact disk read-only memory (CD-ROM), an optical memory device, a magnetic memory device, or any suitable combination of the above. In the present disclosure, the computer-readable storage medium may be any tangible medium containing or storing a program that may be used by or in connection with an instruction execution system, apparatus, or device. The program code contained on the computer-readable storage medium may be transmitted by any suitable medium, including but not limited to wireless, electric wire, optical cable, radio frequency, and the like, or any suitable combination of the above.

The embodiments of the present disclosure further provide a computer program product that, when running on a computer, causes the computer to perform the enterprise activation degree determining method above.

It should be noted that relational terms herein such as “first” and “second” and the like, are used merely to distinguish one entity or business from another entity or business, and do not necessarily require or imply there is any such relationship or order between these entities or operations. Furthermore, the terms “including”, “comprising” or any variations thereof are intended to embrace a non-exclusive inclusion, such that a process, method, article, or device including a plurality of elements includes not only those elements but also includes other elements not expressly listed, or also includes elements inherent to such a process, method, article, or device. In the absence of further limitation, an element defined by the phrase “including a . . . ” does not exclude the presence of additional identical element in the process, method, article, or device.

The above are only specific embodiments of the present disclosure, so that those skilled in the art can understand or realize the present disclosure. Many modifications to these embodiments will be obvious to those skilled in the art, and the general principles defined herein can be implemented in other embodiments without departing from the spirit or scope of the present disclosure. Therefore, the present disclosure will not to be limited to these embodiments shown herein, but is to be in conformity with the widest scope consistent with the principles and novel features disclosed herein.

### INDUSTRIAL APPLICABILITY

The dimensionless processing is performed on the original activation degree index data in the P dimensions to obtain the target activation degree index data in the P dimensions respectively corresponding to the N enterprises, so as to eliminate the influence of dimensions, and make the evaluation results more interpretable. Through the principal component analysis method, dimension reduction process is performed on the target activation degree index data in the P dimensions to determine the M principal components and the accumulated contribution rates respectively corresponding to the M principal components where M is a positive integer less than P. Because each principal component is the linear combination of the target activation degree index data in the P dimensions, the weights respectively corresponding to the target activation degree index data in the P dimensions are calculated by combining the accumulated contribution rates corresponding to each principal component. For example, the coefficients of the target activation degree index data in the same dimension in the principal components may be weighted and averaged, so that the accuracy of weight determining can be improved. Furthermore, for each enterprise, the activation degree of the enterprise is determined according to the target activation degree index data in the P dimensions corresponding to the enterprise and the weights respectively corresponding to the target activation degree index data in the P dimensions, so that the accuracy of activation degree determining can be improved.

What is claimed is:

1. An enterprise activation degree determining method, comprising:
acquiring original activation degree index data in P dimensions corresponding to N enterprises respectively, and performing a dimensionless processing on the original activation degree index data to obtain target activation degree index data in P dimensions respectively corresponding to the N enterprises; wherein both N and P are an integer greater than 1;
calculating a correlation coefficient of target activation degree index data in every two dimensions in the target activation degree index data in the P dimensions to obtain a correlation coefficient matrix, and determining feature values and feature vectors of the correlation coefficient matrix;
determining accumulated contribution rates of P components based on the feature values and the feature vectors, and determining M principal components according to the accumulated contribution rates of the P components and accumulated contribution rates respectively corresponding to the M principal components; wherein, each principal component is a linear combination of the target activation degree index data in the P dimensions, and M is a positive integer less than P;
calculating weights respectively corresponding to the target activation degree index data in the P dimensions according to coefficients of the target activation degree index data in the P dimensions in the M principal components and the accumulated contribution rates respectively corresponding to the M principal components; wherein, the coefficients of the target activation degree index data in the P dimensions are determined based on the feature vectors; and
for each enterprise, determining an activation degree of the enterprise according to the target activation degree index data in the P dimensions corresponding to the enterprise and the weights respectively corresponding to the target activation degree index data in the P dimensions.

2. The method according to claim 1, wherein the step of calculating the weights respectively corresponding to the target activation degree index data in the P dimensions according to the coefficients of the target activation degree index data in the P dimensions in the M principal components and the accumulated contribution rates respectively corresponding to the M principal components comprises:
when an i-th principal component Fᵢ is denoted as:
$${F}_{i} = {a}_{1 i} {X}_{1} + {a}_{2 i} {X}_{2} + … + {a}_{p i} {X}_{p} , i = 1 , 2 , … , M ;$$
and
a corresponding accumulated contribution rate corresponding to Fᵢ is denoted as pᵢ, according to the following formula:
$${w}_{k} = \frac{{\sum }_{i = 1}^{M} {a}_{ki} {P}_{i}}{{\sum }_{i = 1}^{M} {P}_{i}} , k = 1 , 2 , … , p ,$$
determining a weight wₖ corresponding to target activation degree index data in a k-th dimension, wherein X₁, . . . , Xₚ respectively denote target activation degree index data in the first to p-th dimensions, and a₁ᵢ, . . . , aₚᵢ are the coefficients of the target activation degree index data in the P dimensions.

3. The method according to claim 2, wherein after calculating the weights respectively corresponding to the target activation degree index data in the P dimensions, the method further comprises:
normalizing the weights respectively corresponding to the target activation degree index data in the P dimensions to obtain normalized weights respectively corresponding to the target activation degree index data in the P dimensions; and
the step of determining the activation degree of the enterprise according to the target activation degree index data in the P dimensions corresponding to the enterprise and the weights respectively corresponding to the target activation degree index data in the P dimensions comprises:
determining the activation degree of the enterprise according to the target activation degree index data in the P dimensions corresponding to the enterprise and the normalized weights respectively corresponding to the target activation degree index data in the P dimensions.

4. The method according to claim 1, wherein the steps of determining the accumulated contribution rates of the P components and determining the M principal components according to the accumulated contribution rates of the P components and the accumulated contribution rates respectively corresponding to the M principal components comprises:
sorting the feature values in a descending order, and calculating the accumulated contribution rates of the P components based on the sorted feature values; and
when M feature values are corresponding to the accumulated contribution rates greater than a preset threshold in the accumulated contribution rates of the P components, taking the first to M-th principal components corresponding to the M feature values as the M principal components.

5. The method according to claim 1, wherein the step of performing the dimensionless processing on the original activation degree index data to obtain the target activation degree index data in the P dimensions respectively corresponding to the N enterprises comprises:
calculating an average value and a standard deviation of the original activation degree index data in a q-th dimension of the N enterprises; and
for each enterprise, dividing a difference between the original activation degree index data in the q-th dimension of the enterprise and the average value by the standard deviation as target activation degree index data in the q-th dimension of the enterprise.

6. The method according to claim 1, wherein before performing the dimensionless processing on the original activation degree index data, the method further comprises:
performing at least one of an index forward processing and an index normalization processing on the original activation degree index data to obtain pre-processed activation degree index data; and
the step of performing the dimensionless processing on the original activation degree index data comprises:
performing the dimensionless processing on the pre-processed activation degree index data.

7. The method according to claim 1, wherein the method further comprises:
after determining activation degrees of the N enterprises, dividing the activation degrees of the N enterprises into a plurality of different activation degree levels, and excluding enterprises contained in a lowest activation degree level.

8. An enterprise activation degree determining apparatus, wherein the apparatus comprises:
a dimensionless processing module, wherein the dimensionless processing module is configured for acquiring original activation degree index data in P dimensions corresponding to N enterprises respectively and performing a dimensionless processing on the original activation degree index data to obtain target activation degree index data in P dimensions respectively corresponding to the N enterprises; wherein both N and P are an integer greater than 1;
a feature value and feature vector determining module, wherein the feature value and feature vector determining module is configured for calculating a correlation coefficient of target activation degree index data in every two dimensions in the target activation degree index data in the P dimensions to obtain a correlation coefficient matrix and determining feature values and feature vectors of the correlation coefficient matrix;
a principal component and accumulated contribution rate determining module, wherein the principal component and accumulated contribution rate determining module is configured for determining accumulated contribution rates of P components based on the feature values and the feature vectors and determining M principal components according to the accumulated contribution rates of the P components and accumulated contribution rates respectively corresponding to the M principal components; wherein, each principal component is a linear combination of the target activation degree index data in the P dimensions, and M is a positive integer less than P;
a weight determining module, wherein the weight determining module is configured for calculating weights respectively corresponding to the target activation degree index data in the P dimensions according to coefficients of the target activation degree index data in the P dimensions in the M principal components and the accumulated contribution rates respectively corresponding to the M principal components; wherein, the coefficients of the target activation degree index data in the P dimensions are determined based on the feature vectors; and
an activation degree determining module, wherein the activation degree determining module is configured for determining, for each enterprise, an activation degree of the enterprise according to the target activation degree index data in the P dimensions corresponding to the enterprise and the weights respectively corresponding to the target activation degree index data in the P dimensions.

9. An electronic device, comprising: a processor, wherein the processor is configured for executing a computer program stored in a memory, and the computer program, when executed by the processor, implements the steps of the method according to claim 1.

10. A computer-readable storage medium storing a computer program thereon, wherein the computer program, when executed by a processor, implements the steps of the method according to claim 1.

11. The electronic device according to claim 9, wherein in the method, the step of calculating the weights respectively corresponding to the target activation degree index data in the P dimensions according to the coefficients of the target activation degree index data in the P dimensions in the M principal components and the accumulated contribution rates respectively corresponding to the M principal components comprises:
when an i-th principal component Fᵢ is denoted as:
$${F}_{i} = {a}_{1 i} {X}_{1} + {a}_{2 i} {X}_{2} + … + {a}_{p i} {X}_{p} , i = 1 , 2 , … , M ;$$
and
a corresponding accumulated contribution rate corresponding to Fᵢ is denoted as pᵢ, according to the following formula:
$${w}_{k} = \frac{{\sum }_{i = 1}^{M} {a}_{ki} {P}_{i}}{{\sum }_{i = 1}^{M} {P}_{i}} , k = 1 , 2 , … , p ,$$
determining a weight wₖ corresponding to target activation degree index data in a k-th dimension, wherein X₁, . . . , Xₚ respectively denote target activation degree index data in the first to p-th dimensions, and a₁ᵢ, . . . , aₚᵢ are the coefficients of the target activation degree index data in the P dimensions.

12. The electronic device according to claim 11, wherein in the method, after calculating the weights respectively corresponding to the target activation degree index data in the P dimensions, the method further comprises:
normalizing the weights respectively corresponding to the target activation degree index data in the P dimensions to obtain normalized weights respectively corresponding to the target activation degree index data in the P dimensions; and
the step of determining the activation degree of the enterprise according to the target activation degree index data in the P dimensions corresponding to the enterprise and the weights respectively corresponding to the target activation degree index data in the P dimensions comprises:
determining the activation degree of the enterprise according to the target activation degree index data in the P dimensions corresponding to the enterprise and the normalized weights respectively corresponding to the target activation degree index data in the P dimensions.

13. The electronic device according to claim 9, wherein in the method, the steps of determining the accumulated contribution rates of the P components and determining the M principal components according to the accumulated contribution rates of the P components and the accumulated contribution rates respectively corresponding to the M principal components comprises:
sorting the feature values in a descending order, and calculating the accumulated contribution rates of the P components based on the sorted feature values; and
when M feature values are corresponding to the accumulated contribution rates greater than a preset threshold in the accumulated contribution rates of the P components, taking the first to M-th principal components corresponding to the M feature values as the M principal components.

14. The electronic device according to claim 9, wherein in the method, the step of performing the dimensionless processing on the original activation degree index data to obtain the target activation degree index data in the P dimensions respectively corresponding to the N enterprises comprises:
calculating an average value and a standard deviation of the original activation degree index data in a q-th dimension of the N enterprises; and
for each enterprise, dividing a difference between the original activation degree index data in the q-th dimension of the enterprise and the average value by the standard deviation as target activation degree index data in the q-th dimension of the enterprise.

15. The electronic device according to claim 9, wherein in the method, before performing the dimensionless processing on the original activation degree index data, the method further comprises:
performing at least one of an index forward processing and an index normalization processing on the original activation degree index data to obtain pre-processed activation degree index data; and
the step of performing the dimensionless processing on the original activation degree index data comprises:
performing the dimensionless processing on the pre-processed activation degree index data.

16. The electronic device according to claim 9, wherein the method further comprises:
after determining activation degrees of the N enterprises, dividing the activation degrees of the N enterprises into a plurality of different activation degree levels, and excluding enterprises contained in a lowest activation degree level.

17. The computer-readable storage medium according to claim 10, wherein in the method, the step of calculating the weights respectively corresponding to the target activation degree index data in the P dimensions according to the coefficients of the target activation degree index data in the P dimensions in the M principal components and the accumulated contribution rates respectively corresponding to the M principal components comprises:
when an i-th principal component Fᵢ is denoted as:
$${F}_{i} = {a}_{1 i} {X}_{1} + {a}_{2 i} {X}_{2} + … + {a}_{p i} {X}_{p} , i = 1 , 2 , … , M ;$$
and
a corresponding accumulated contribution rate corresponding to Fᵢ is denoted as pᵢ, according to the following formula:
$${w}_{k} = \frac{{\sum }_{i = 1}^{M} {a}_{ki} {P}_{i}}{{\sum }_{i = 1}^{M} {P}_{i}} , k = 1 , 2 , … , p ,$$
determining a weight wₖ corresponding to target activation degree index data in a k-th dimension, wherein X₁, . . . , Xₚ respectively denote target activation degree index data in the first to p-th dimensions, and a₁ᵢ, . . . , aₚᵢ are the coefficients of the target activation degree index data in the P dimensions.

18. The computer-readable storage medium according to claim 17, wherein in the method, after calculating the weights respectively corresponding to the target activation degree index data in the P dimensions, the method further comprises:
normalizing the weights respectively corresponding to the target activation degree index data in the P dimensions to obtain normalized weights respectively corresponding to the target activation degree index data in the P dimensions; and
the step of determining the activation degree of the enterprise according to the target activation degree index data in the P dimensions corresponding to the enterprise and the weights respectively corresponding to the target activation degree index data in the P dimensions comprises:
determining the activation degree of the enterprise according to the target activation degree index data in the P dimensions corresponding to the enterprise and the normalized weights respectively corresponding to the target activation degree index data in the P dimensions.

19. The computer-readable storage medium according to claim 10, wherein in the method, the steps of determining the accumulated contribution rates of the P components and determining the M principal components according to the accumulated contribution rates of the P components and the accumulated contribution rates respectively corresponding to the M principal components comprises:
sorting the feature values in a descending order, and calculating the accumulated contribution rates of the P components based on the sorted feature values; and
when M feature values are corresponding to the accumulated contribution rates greater than a preset threshold in the accumulated contribution rates of the P components, taking the first to M-th principal components corresponding to the M feature values as the M principal components.

20. The computer-readable storage medium according to claim 10, wherein in the method, the step of performing the dimensionless processing on the original activation degree index data to obtain the target activation degree index data in the P dimensions respectively corresponding to the N enterprises comprises:
calculating an average value and a standard deviation of the original activation degree index data in a q-th dimension of the N enterprises; and
for each enterprise, dividing a difference between the original activation degree index data in the q-th dimension of the enterprise and the average value by the standard deviation as target activation degree index data in the q-th dimension of the enterprise.
